(19) United States
(12) Patent Application Publication
(10) Pub. No.: US 2023/0230764 A1
(43) Pub. Date: Jul. 20, 2023

(54) OFFSET TRANSFORMER STRUCTURE

(71) Applicant: Sehat Sutardja, Las Vegas, NV (US)

(72) Inventor: Sehat Sutardja, Las Vegas, NV (US)

(21) Appl. No.: 18/094,292

(22) Filed: Jan. 6, 2023

Related U.S. Application Data
(60) Provisional application No. 63/297,652, filed on Jan. 7, 2022.

(51) Int. Cl. H01F 29/10; H01F 27/28; H01F 27/29

(52) U.S. Cl. CPC H01F 29/10; H01F 27/2804; H01F 27/292

(57) ABSTRACT

A transformer comprising a first signal path in a first plane or layer and a second signal path in the same plane or layer. The second signal path is offset in a diagonally direction in relation to the first signal path, such that the first signal path and the second signal path are in proximity to establish electric-field coupling between the first signal path and the second signal path. A jumper, located in a second plane, is electrically connected to either the first signal path or the second signal path through vias that extend from the first plane to the second plane. The jumper prevents electrical contact between the first and the second signal path at locations where the first and the second signal path would otherwise intersect on the first plane. The shape of the first and second signal paths may be square or rectangular, or both.

### 1. FIELD OF THE INVENTION

The invention is related to transformers and isolation devices and in particular radio frequency (RF) transformers and isolation devices.

### 2. RELATED ART

Miniaturization of radio communication devices has made significant leaps over the last decade with new developments in integrated circuits (IC). These developments have assisted in the miniaturization of many components.

Transformers are commonly used in communication devices to provide a variety of functions such as impedance transformation and isolation, such as between an output amplifier and an antenna. In RF integrated circuits, high frequency RF transformers are also widely used as impedance matching circuits. An example is a step-up output transformer for WIFI and LTE RF power amplifiers. RF transformers are also used to provide common mode isolation or to perform differential to single ended signal conversion (and vice versa).

Transformer physical sizes are however notoriously large in nature when compared to the sizes of transistors in modern silicon technology. Unlike silicon transistors, transformer physical sizes are non-scalable; resulting in higher chip cost when using more advanced silicon process technology. It would therefore be of great interest if these transformers were to have improved performance over prior art designs and still be integrated.

Further, challenges exist in attempts to make integrated transformers capable of operating at high frequencies, such as radio frequency and above. Surface mount transformers are one proposed solution, but such designs are large in size and consume valuable circuit board space thereby limiting circuit size reduction, such designs have limitations in performance and cost.

Integrated transformers are another proposed solution, however integrated circuits also pose challenges as circuits and systems operate at higher frequencies. For example, prior art circuit designs, when presented with high frequency signals, suffered from unwanted reflections from a secondary side winding to a primary side winding, high capacitance, and poor Q or K factors.

A transformer could either be a step-up or a step-down transformer, or simply a unity transformer with a transformation ratio of N1:N2, N2:N1 or simply 1:1 respectively; where N1 and N2 are integer numbers equal or higher than 1. At the upper GHz operating frequencies (beyond around 5 GHz), N2 is usually set at the lowest possible integer number which is equal to “1” in order to achieve the highest possible Quality Factor Q.

For a step-down transformer at the upper GHz operating frequencies the transformer is therefore normally denoted as an N1:1 transformer. Conversely for a step-up transformer it is normally denoted as a 1:N1 transformer. Even at the lower GHz operating frequencies where higher inductances are required for the transformer windings, it is very rare we see N2>2. Therefore, even at the lower GHz frequency range, transformer designs don't normally use, for example an 8:4 transformer. Instead, a transformer will more likely be a 4:2 transformer to achieve an equivalent 2:1 ratio.

Therefore, there is a need in the art for a transformer design which optimizes space consumption while also having performance parameters that do not degrade system performance. Concurrently, the transformer is required to have a high coupling coefficient, low resistance, and minimize reflection from the higher voltage winding to the lower voltage winding.

### SUMMARY

When designing and constructing RF transformers, there are several factors to consider and several challenges to overcome. As used herein, the term RF is defined to mean, but is not limited to, cellular bands, WIFI bands and millimeter wavelength bands, such as but not limited to ½ GHz to 100 Ghz. The designs disclosed here may also be used, to gain the benefits described below, in integrated circuits, or in non-integrated application, either as part of a printed circuit board or as a discrete separate element. Any embodiment disclosed herein may be embodied as an integrated transformer, as part of a printed circuit board, or as a separate discrete element such as mounted on a circuit board or a free-standing element. For example, TV bands are at a frequency range which may not be suited for integration, but which would still benefit from the transformer designs disclosed herein. One aspect to consider and which must be optimized or balanced with other performance parameters is the K factor, defined as the coupling coefficient. The K factor refers to the fraction or amount of magnetic flux produced by one winding that couples into a second winding. A higher K factor, up to a maximum of one, is ideal.

The Q factor is also an important design consideration. The Q factor is typically used in reference to inductors and sometimes for transformers. For a transformer, the Q factor may be considered an indicator of loss within the transformer due to resistance/impedance. The higher the Q factor, the lower the losses within the transformer due to lower resistance. Thus, a higher Q factor is preferred to reduce signal loss and attenuation. Typically, for integrated inductors the Q factor is not greater than 10 while discrete coil wire inductors can have a Q factor as high as 60.

While it is desirable to have a high Q factor, achieving this at the expense of other transformer operational parameters is unwanted. For example, increasing the Q factor may come at the expense of a resonance frequency that is too low for the desired operating frequency. A transformer with too much capacitance may be useless for radio frequencies if the resonance frequency is too low. For example, if the operating frequency is 5 GHz but the resonance frequency is 4 GHz, then the transformer is not usable for this application. It is preferred for the transformer to have a resonance frequency that is higher than the operating frequency.

Another factor that must be considered when designing a RF transformer is capacitance. This is a significant design challenge in prior art transformers. As is understood in the art, capacitance occurs when a conducting conductor is adjacent another conductor. This is a common arrangement in a transformer where flux coupling occurs. The capacitance is typically balanced with the coupling coefficient K, which is also important. It is preferred to have a K factor of 1, which is ideal. However, in an RF transformer, it is almost impossible to have a K factor of one because there must be an inner space filled with an insulating material, between the primary to secondary winding, and thus the winding spacing cannot be zero area or very close to zero area. While the coupling coefficient K is improved if the spacing between the primary and secondary winding is reduced, the reduction in spacing also then increases capacitance.

In the prior art, this converse relationship limited RF transformer performance. For example, it is preferred to have a high resonance frequency, but to achieve this, capacitance should be maintained low. To maintain a low capacitance, a larger distance between the primary winding and the secondary winding is required, yet this reduces the K factor. However, it is also preferred to have a high K factor. For the K factor to be high, the spacing between the primary and secondary windings should be minimized. This in turn creates more capacitance. These competing performance factors make RF transformer design difficult.

In addition, the insulating material separating the primary and secondary coils in an integrated transformer is typically plastic, glass, or silicon, which has magnetic properties generally equivalent to air. This material does not provide ideal coupling, thereby not optimizing the K factor.

Another design issue is due to the K factor from the primary side winding to the secondary side winding being dependent on the voltage seen on the secondary side winding. If building a transformer that steps up voltage, for example from 1 V to 10 V, then the capacitance from the primary side winding to the secondary side winding is not referenced from ground but is referenced from 10 volts. Usually, capacitance is measured or referenced from ground, but in this case, it is compared to 10 volts on the secondary side winding. The secondary side winding often has a higher voltage than the primary side winding. This has the effect of multiplying the capacitance by the voltage gain of the transformer. This occurrence is similar to the Miller Effect which concerns capacitance and amplification.

Typically, the capacitance from the primary side winding to the secondary side winding is multiplied by the amount that voltage is stepped up. For step up transformers, this presents a design challenge because with the increased capacitance, the frequency will collapse, and the circuit output will be highly distorted. The primary side circuit will see the signal being transmitted because the secondary side signal will couple back into the primary side. The reflected signal appears as an interferer to the primary side circuit.

In addition, most circuits are differential, but the antenna is single ended with the opposing terminal connected to, or referenced, to ground. This results in coupling from the single ended side which is unbalanced yielding unwanted harmonics including a very high amount of odd order harmonics. High amounts of harmonic signals are not allowed by government regulations because a transmit system is not allowed to transmit outside of its authorized frequency band, and such harmonics reduce transmit signal quality. High order harmonics cross/inter modulate with each other, thus creating unwanted in-band interference signals which may appear in the baseband.

To overcome the drawbacks of the prior art and provide additional benefits, an integrated transformer is disclosed that includes a flat substrate, a primary side winding and a secondary side winding.

The primary side winding, on the substrate, comprising a conductor having a first primary terminal and a second primary terminal. The secondary side winding, on the substrate, comprises two or more fractional sections connected in parallel, which together form a complete turn such that each of the two or more fractional sections are adjacent the primary side winding to maximize coupling. The term primary side winding should be interpreted to be one or more windings. The term secondary side winding should be interpreted to be one or more windings.

To overcome the drawbacks of the prior art and provide additional benefits, a transformer is disclosed that includes a first signal path in a first plane and a second signal path, in the first plane. The second signal path is offset in a diagonal direction in relation to the first signal path. The first signal path and the second signal path are in proximity to establish electric-field coupling between the first signal path and the second signal path. A jumper, which is located in a second plane, connects to either the first signal path or the second signal path to prevent electrical contact between the first signal path and the second signal path.

In one embodiment, the first and second signal paths are each comprised of one or more windings, and the transformer is formed in an integrated circuit or a printed circuit board. The jumper may connect to the first signal path or the second signal path with vias that extend from the second plane to the first plane. In one configuration, the first signal path comprises two or more windings connected in parallel, and the second signal path comprises two or more windings also connected in parallel, such that the first signal path and second signal paths are in the shapes of squares or rectangles

It is contemplated that the first signal path may include one or more input terminals and the second signal path may include one or more output terminals. In one embodiment, the primary side and the secondary side are a twisted structure which form a twisted transformer configuration. The first signal path, the second signal path, or both may be configured with fractional turn windings. The shape of the signal paths may form two or more square or rectangular shape and the second signal path is of the same general shape as the first signal path.

Also disclosed is a transformer comprising a first and second primary side winding and a secondary side winding. The primary side winding is electrically connected to a primary side terminal, located in a first layer of a semiconductor device or printed circuit board. The second primary side winding is electrically connected to the primary side terminal and is also located in the first layer. A secondary side winding, electrically connected to a secondary side terminal, is located in the first layer, such that the secondary side winding is located between the first primary side winding and the second primary side winding such that the first primary side winding, second primary side winding, and the secondary side winding are diagonally offset from one another and in proximity to establish for electric field coupling.

This transformer may further comprise two or more vias that connect to at least one of the windings and extend to a layer different than the first layer, and one or more jumpers. The jumper connects to at least two of the two or more vias to route two or more windings to a different layer to prevent electrical connection between the windings which are in the first layer. An insulating material is provided on the first layer between the first primary side winding and the secondary side winding, and between the secondary side winding and the second primary side winding to prevent electrical connection between the windings.

The transformer may be configured as a step-up transformer or a step-down transformer. In one embodiment, the transformer further comprises one or more amplifiers connected to the primary side terminal, the secondary side terminal, or both. In one configuration, the primary side winding, the secondary side winding, or both are fractional turn windings.

Also disclosed is a transformer structure comprising one or more primary side windings and one or more secondary side windings. The primary side windings form a conductive path between two terminals and the primary side windings are in the shape of two or more squares, rectangles or a combination of both. The one or more secondary side windings have the same shape as the one or more primary side windings, but are diagonally offset from the one or more primary side winding and adjacent at least one of the one or more primary side windings to experience electric field coupling from the at least one of the one or more primary side windings.

In one configuration the transformer further comprises jumpers on a different layer to prevent electrical contact between the primary side windings and the secondary side windings, such that the one or more primary side windings and the one or more secondary side windings are on a same layer, except for the jumpers which are on the different layer. This configuration may further comprise, at overlap points between the one or more primary side windings and/or the one or more secondary side windings, vias that extend to a jumper that is a different layer to prevent the conductive paths from touching at overlap points. The one or more primary side windings have one or more input terminals and the secondary side winding has one or more output terminals. It is contemplated that the one or more secondary side windings are interleaved with (between) the one or more primary side windings. The one or more primary side windings and the one or more secondary side windings may be in the shape of two or more diamonds which are adjacent transistors.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an example embodiment of a two winding diagonally offset transformer.

FIG. 2A illustrates a transformer with diagonal offset winding shape.

FIG. 2B illustrates a four winding transformer with an enlarged section of winding overlap.

FIG. 2C illustrates the embodiment of FIG. 2B, but with an additional primary side winding which establishes the secondary side winding as fully interleave between the primary side winding.

FIG. 2D illustrates an alternative embodiment of the diagonally offset transformer structure having a terminal for each winding.

FIG. 2E illustrates the transformer of FIG. 2D with exemplary amplifier connections.

FIG. 2F illustrates an alternative transformer embodiment having two primary side windings that are one turn winding, while the secondary side winding is a ¼ turn winding.

FIG. 3 illustrates a diagonally offset transformer structure with associated amplifiers.

FIG. 4A illustrates an alternative winding structure with windings configured as diagonally offset triangle shapes.

FIG. 4B illustrates an example embodiment of a transformer winding arrangement with rectangular shaping windings.

FIG. 5 illustrates an example embodiment of a transformer with coupled windings, and the coupled windings connect to amplifiers as shown.

FIG. 6A illustrates an alternative winding structure with a central twist forming two or more square or rectangular shapes.

FIG. 6B illustrates a perspective view of a jumper and via configuration which prevents intersecting windings from touching.

In FIG. 7 disclosed is a twisted transformer structure using two or more of the twisted windings which are diagonally offset as disclosed herein.

FIG. 8A illustrates an alternative winding configuration with an input terminal that connects to one winding that is twisted into three smaller square windings.

FIG. 8B illustrates an alternative winding configuration with rectangular windings.

FIG. 9 illustrates an exemplary twisted transformer structure and associated transistor banks.

### DETAILED DESCRIPTION

One challenge faced with prior art designs which utilize concentric circles is that as the circle decreases in size, the diameter of the inner circle becomes smaller and smaller. For example, some prior art proposed transformers used circle shapes, such as an inner winding and a larger outer winding. As can be seen, the different windings have different diameters and different winding lengths for each wind due to the difference in circumference of each winding, which is proportional to the winding diameter. The inner windings are smaller than the outer diameter. This causes the inner inductance to be smaller than the outer inductance because inductance L is proportional to area. This is a drawback because there are different inductances between windings. Another drawback the use of circle shapes for transformer windings or shapes which resemble circles is that fabricating conductive circuits at other than right angles is difficult for fabricators and generally undesirable. For example, designs which have conductive traces change direction at an acute angle may be not be fabricatable and are a less preferred design. While other angles are contemplated, 90 degrees is the preferred angle for changes in direction of a winding and for overlaps between windings. Offset triangular shapes can be used.

The new structure disclosed below overcomes the drawbacks of the prior art by using a diagonally shifted winding which may be used with different geometric shapes, and which preferably have the same or similar area, winding length, or both to maintain a uniform inductance. For example, squares, rectangles, triangles, pentagons, and hexagons are also envisioned as a possible design shape as is any other shape. However, when the shape becomes similar to a circle or is a circle, integrated circuit fabrication challenges are presented. This allows the proposed design to fit into a limited circuit board or integrated circuit space, although slightly less than optimal coupling may result.

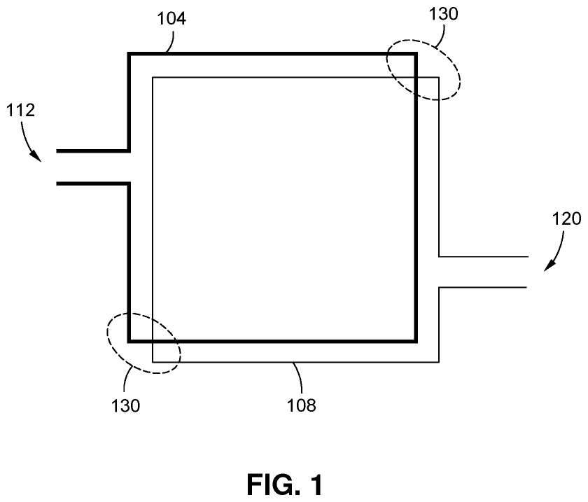

Disclosed is an improved transfer winding structure which overcomes numerous drawbacks of the prior art. Any of the designs and configurations may be arranged in the diagonal offset pattern shown in FIG. 1.

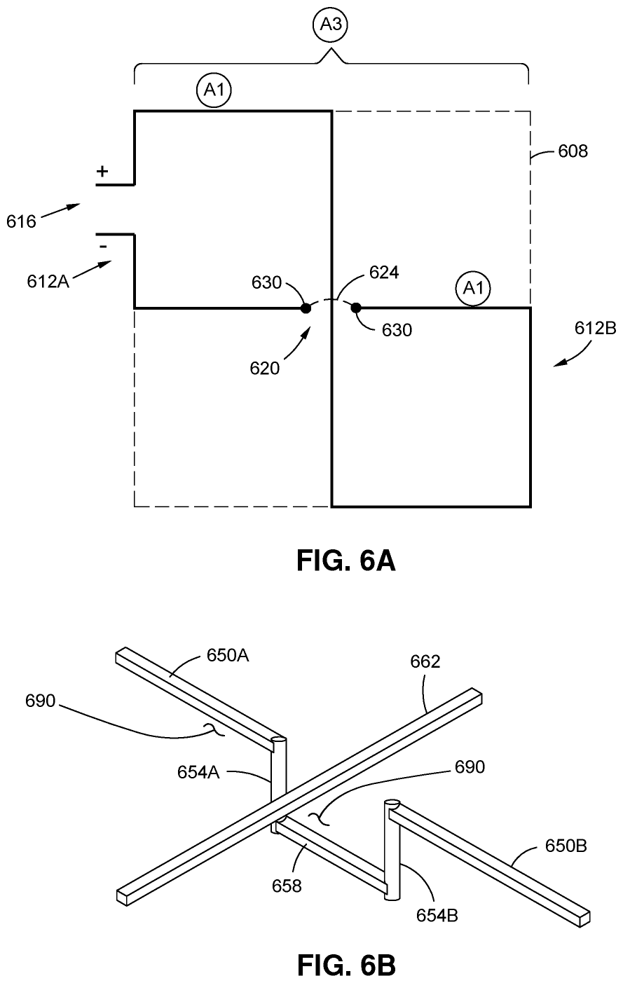

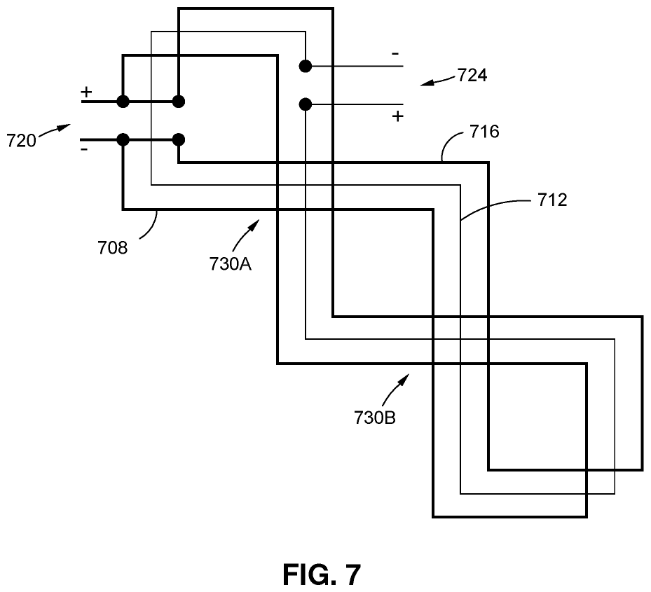

In this embodiment, there is a first winding 104 and a second winding 108. The second winding 108 is offset diagonally from the first winding 104. The term offset diagonally means that one winding is generally the same as the other winding (primary winding is generally the same as the secondary winding) but is shifted to the side and up, which in this embodiment is a shift at a 45 degree angle. The windings can be shifted or move in different directions, such as different distances and at different angles. This may be referred to as a diagonal shift. The overlap regions 230 cross on different levels or layers of the material in which the transform is formed and are connected by a jumper in a different layer. The jumper (on the different layer) is connected to the main trace with a via. A jumper is shown in more detail in FIG. 6B.

The offset may be any distance, such as but not limited to the minimum allowed by the manufacturing process. The distance between each of the input terminals and each of the output terminals may be any distance such as not limited to the minimum distance allowed by the manufacturing process. This distance may be 1 to 3 microns with an insulating layer or material therebetween. As can be seen in this embodiment, each of the sides of the square windings is the same length, however in other embodiment other shapes are contemplated. In addition, the distance between the positive and negative terminals of a winding may be any distance apart. In one embodiment the distance between the terminals is as close as allowed by the manufacturing process. In one embodiment the distance is between 1 to 4 microns. Between the windings and between the terminals is an insulating material to prevent shorting of the windings and/or terminals.

The first winding 104 has first winding terminals 112, while the second winding 108 has second winding terminals 114. The terminals are typically referred to with positive (+) and negative (−) designations and establish inputs to and outputs from the transformer. As can be seen in FIG. 1, the length of the first winding 104 and the second winding 108 is generally the same, and the spacing between the first winding and the second winding 108 is symmetric and generally the same. As a result, coupling efficiency, such as the coupling coefficient K is optimized as is typically a 10% to 20% improvement over the prior art and the coupling is uniform due to the uniform size of the first winding 104 and the second winding 108. One of ordinary skill in the art will understand that an ideal transformer would have a coupling coefficient K of 1, but this is not possible in actual implementations. The disclosed embodiments can achieve a coupling coefficient of 0.9 or greater, while prior art spiral transformers only achieved a K factor of 0.7. This is a significant improvement over the prior art spiral inductor designs that spiraled from a large diameter to a smaller diameter, which had an inner winding which was a different size than an outer winding or a different layer. Spiral inductors or transforms have windings which are not the same diameter, or which have different inner areas. In addition, although shown as single turn windings, it is contemplated that the diagonally offset design may be configured with any number of winding turns in addition or other than that shown in the figures. For example, the primary side winding may have two or more turns while the secondary side winding may have a single turn, or more than one turn. Thus, the primary side winding may have more turns than the secondary side winding, or the secondary side winding may have more turns than the primary side winding. Having a greater number of windings will increase coupling but will increase the size of the transformer.

As shown in FIG. 1, the primary and secondary windings may have the same number of turns. In addition, the primary side windings may comprise one or more winding and the secondary side winding may also comprise one or more windings. Any number of input/output terminals may be associated with each winding. Any of the diagonally offset winding embodiments disclosed herein may have fractional windings, which are shown and discussed below.

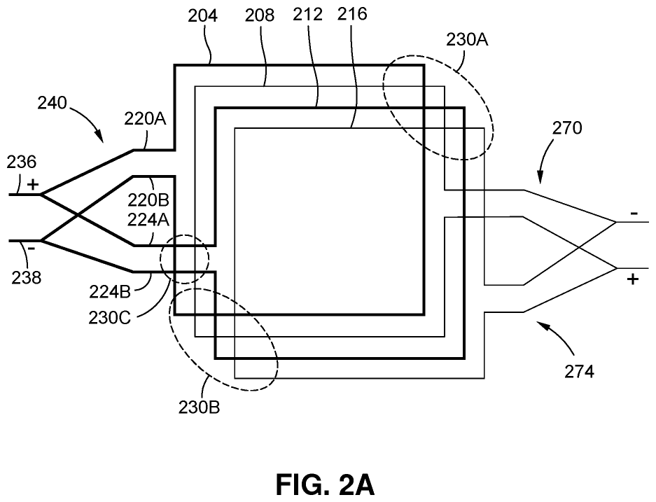

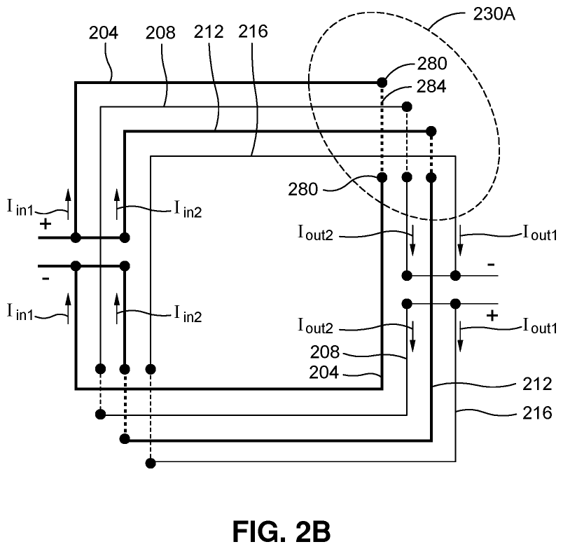

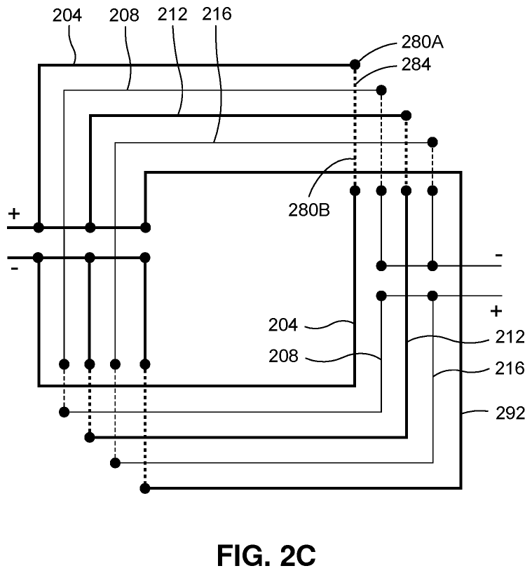

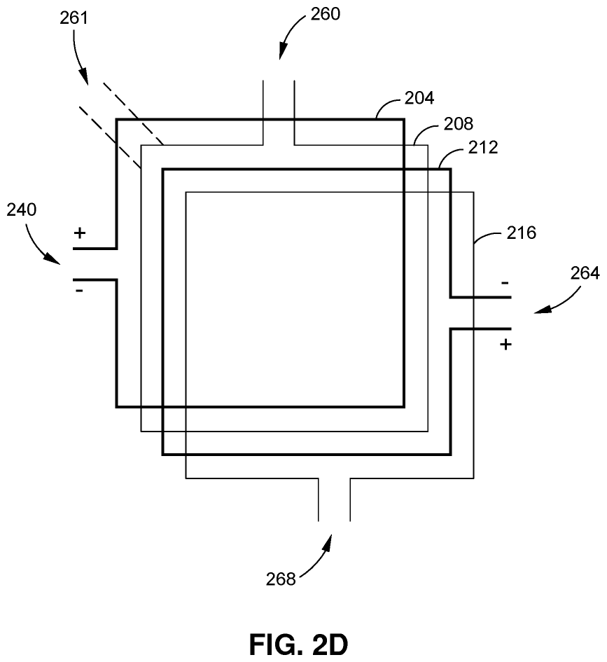

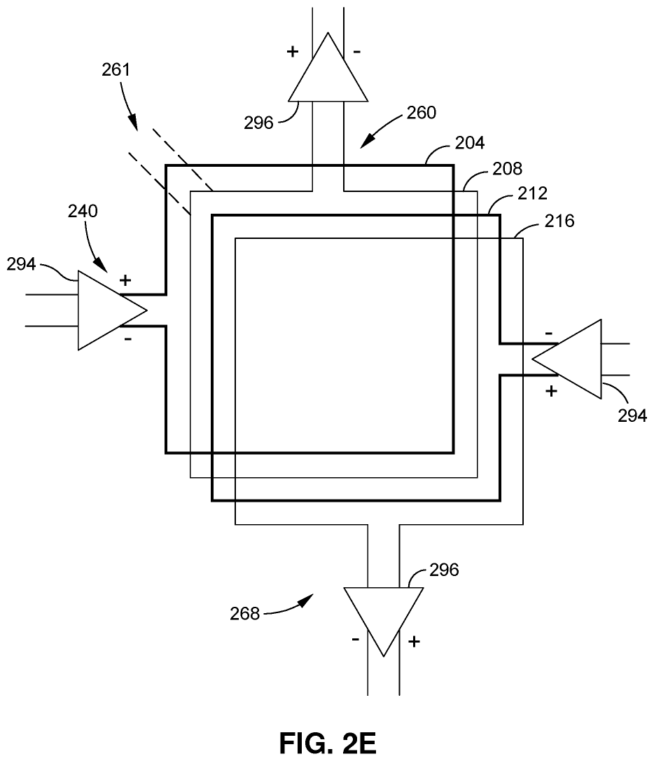

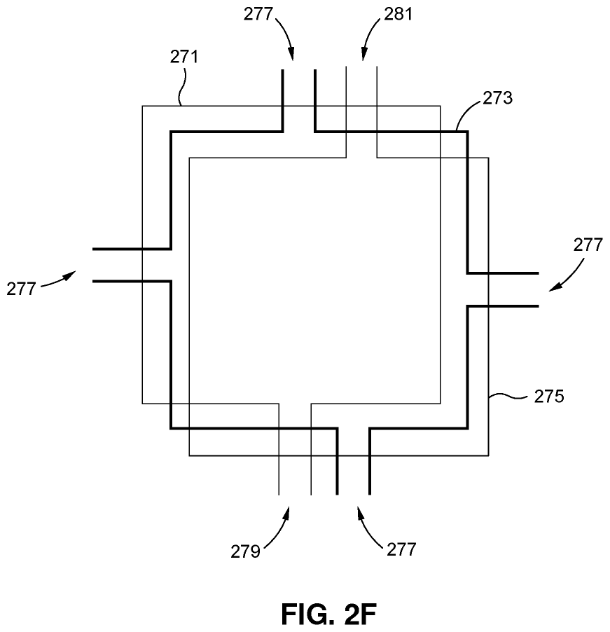

The transformer design shown in FIG. 2A includes four generally square windings, which are offset in a diagonal pattern, which may be referred to as diagonally offset. The design includes a first winding 204, a second winding 208, a third winding 212, and a fourth winding 216. As shown, each winding is a single turn and is generally square in shape forming a 1:1 winding ratio. In other embodiments, any other winding ratios may be established by changing the number of turns on the primary or secondary windings and any number of windings may be used. The first winding 204 has two terminals, namely a positive input terminal 220A and a negative input terminal 220B. The third winding 212 has two input terminals, namely a positive input terminal 224A and a negative input terminal 224B. These terminals are connected as shown to establish a positive terminal 236 and a negative terminal 238. The first winding 204 and the third winding 212 are the primary side windings. The parallel structure between windings (primary and secondary) with interleaving between windings maximizes coupling. The designs disclosed herein have ideal coupling.

The second winding 208 and the fourth winding 216 are the secondary side windings. The second winding 208 includes a second winding terminal 270 while the fourth winding 216 includes a fourth winding terminal 274. The second winding terminal 270 and the fourth winding terminal 274 are connected as shown.

As can be seen in FIG. 2A, the first winding 204 is adjacent the second winding 208. The second winding 208 is between the first winding 204 and the third winding 212. Adjacent the third winding 212 is the fourth winding 216. Either of the windings may be primary or secondary, however, there is interleaving of windings between the primary and secondary windings. Each winding is sufficiently proximate another winding to allow EMF to be induced in the adjacent winding, thus generating a current in the adjacent winding, such as from the primary side windings 204, 212 into the secondary side windings 208, 216. As can be seen, each of the four windings have the same length and inner area, leading to each winding generating the same inductance.

In this embodiment, the secondary side winding(s) 208 are interleaved between the first winding 204 and the third winding 212. Interleaving windings maximizes coupling by having a primary winding on each side of the secondary winding. Coupling could be further increased by adding a fifth winding adjacent the fourth winding 216. This would then sandwich or interleave the fourth winding 216 between two primary side windings.

A winding overlap or cross over occurs in areas 230A, 230B, 230C where two windings cross. FIG. 2B illustrates an enlarged section of winding overlap 230A as shown in FIG. 2A. The windings 204, 208 212, 216 are shown in FIG. 2A. In relation to the first winding 204, the first winding connects to a first via 280A, a vertical connection path, which connects to an interconnect 284, also referred to as a jumper, that is located on a different layer, such as a layer above, below the layer, or a combination of both, on which the windings 204, 208 212, 216 are located. The interconnections could also be in the other direction (orthogonal) such as horizontally aligned and interconnected in the orthogonal direction. At an opposing end of the interconnect 284 is a second via 280B which connects to the winding 204. The other windings have a similar jumper structure which interconnects on a different layer. At the opposing corner crossovers to maintain a generally equal length for each winding, the jumper locations 230A, 230B may be balanced by swapping jumper locations. Thus, the winding with a long jumper length at one corner may be configured with a short jumper length at the opposing corner.

A discussion of the current flows in the embodiment of FIG. 2B is provided. This explanation of the current flow may be applied to the other winding structuring shown and disclosed herein. As shown, current Iin2 is the same as current Iin2 due to the two windings 204 being in parallel with winding 212.

FIG. 2C illustrates the embodiment of FIG. 2B, but with an additional winding 292 which establishes the secondary side winding as fully interleave between the primary side windings. Thus, the primary side windings includes three individual windings 204, 212, and 292. The secondary side winding comprises windings 208 and 216 which are sandwiched between the ss to maximize coupling from the primary to the secondary winding.

FIG. 2D illustrates an alternative embodiment of the diagonally offset transformer structure having a terminal for each winding. The windings 204, 208, 212, 216 are arranged as shown and each winding has a terminal. In particular, the first winding 204 includes terminal 240. The second winding 208 includes terminal 260. The third winding 212 includes terminal 264. The fourth winding 216 includes terminal 268. In various other embodiments, each winding may have a greater or fewer numbers of terminals. The port (input or output) of the winding may be located anywhere along the winding, such as at the middle, corner 261, or anywhere between the two the locations shown.

FIG. 2E illustrates the transformer of FIG. 2D with exemplary amplifier connections shown. In this embodiment, output of amplifiers 294 are shown as connected to the first winding 204 and the third winding 212. The outputs of the secondary side windings 208, 216 are connected to the inputs of amplifiers 296. This provides electrical isolation between the amplifiers while creating a high K factor for coupling of energy between windings. Other connection arrangements are possible and contemplated.

FIG. 2F illustrates an alternative embodiment having a two primary side windings 271, 275 that are one turn windings while the secondary side winding 273 is a ¼ turn winding because it has four output terminals 277. As shown, the secondary winding 273 is located between and in proximity to the first winding 271 and the third winding 275. The one turn windings 271, 275 only have one terminal 281, 279. This creates a 4:1 or 1:¼ transformer. Other ratios are contemplated such as ⅓ turn or ½ turn or any other fraction, in either or both of the primary or secondary side. These configurations will step up voltage, which also steps down current, or to step down the voltage, which steps up the current. This provides a highly efficient, small, low cost, voltage and current conversion mechanism. It should be understood that the same transformer may be switched between a step-up and step-down function by reversing the primary side and secondary side connection.

The primary side and secondary side winding designation may be reversed, such that the primary side winding is winding 273 while the secondary side windings are windings 271, 275. This would be a ¼:1 or 1:4 transformer. This may be referred to as a step up or step down transformer. Other turn ratios are contemplated. Based on the disclosure herein the transformer may be any structure with different port opening locations and numbers, in any location, or fractional windings. These features may be combined in any arrangement.

Although shown as three distinct windings, it is contemplated that a fewer or greater number of windings may be part of the transformer. In addition, different winding interleaving arrangements are possible.

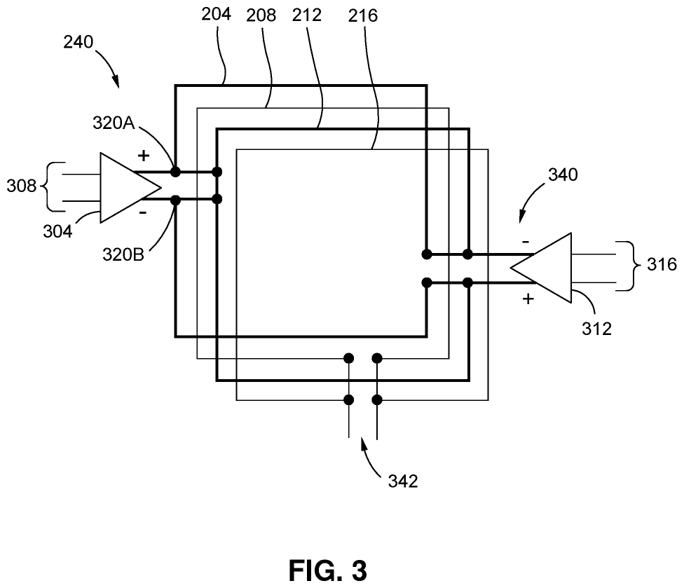

FIG. 3 illustrates a diagonally offset transformer structure with associated amplifiers. This is but one possible configuration of the diagonally offset structure and the transformer with associated amplifiers may have any number of windings, turns and optional fractional turns. As compared to FIG. 2A, similar or identical elements are labeled with identical reference numbers. In addition to the structure of FIG. 2A, also included are a first amplifier 304 and a second amplifier 312. The first amplifier 304 includes input terminals 308 while the second amplifier 312 includes input terminals 316. In FIG. 3, the first winding 202 is configured as a ½ turn winding thereby providing two terminals or taps, namely terminals 240, 340. The turn ratio is a 1:2 with a step-up configuration from the primary side windings 204, 212 to the secondary side windings 208, 216. In this configuration, the voltage on the output 432 is two times the voltage on the input, although some voltage may be lost due to the coupling coefficient being less than 1. This may also be referred to a ½:1 transformer. The primary and secondary windings may be reversed.

The ratio values may change to other values and the relationship may change as well, such as modification to a 2:1 turn ratio, or 3:1, 4:1, or 1:4, 1:3, 1:2 ratios or any other values M:N where M and N are any whole number or fractional values. The second winding 212 and fourth winding 216 include a single terminal 342 configured as shown. Each amplifier 304, 312 is driving one half of a winding turn. The polarity is shown on each amplifier output to drive each terminal in opposite direction. The parallel windings may also be driven by a single amplifier, by different amplifiers, or an amplifier may only drive a portion of a winding. As would be understood in the art, various permutations are possible, and any feature of any embodiment may be combined with any feature of any other embodiment. The transformer of FIG. 3 has two primary side windings and two secondary side windings. In other embodiment, the primary side may have an additional winding or the secondary winding may have an additional winding such that the primary side has an odd number of windings while the secondary side has an even number of windings, or the primary side has an even number of windings while the secondary side has an odd number of windings. This even:odd or odd:even arrangement maximizes coupling.

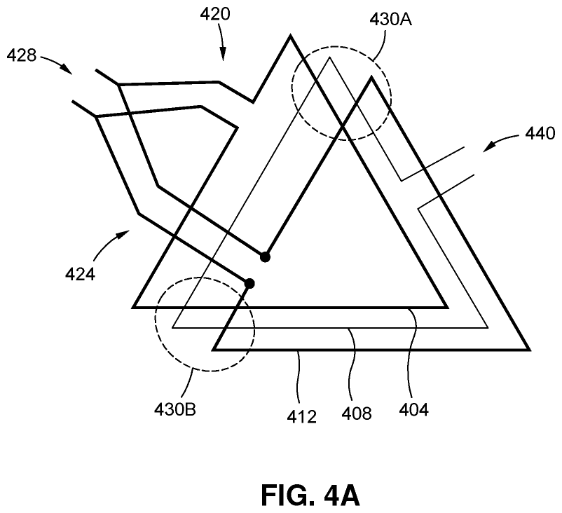

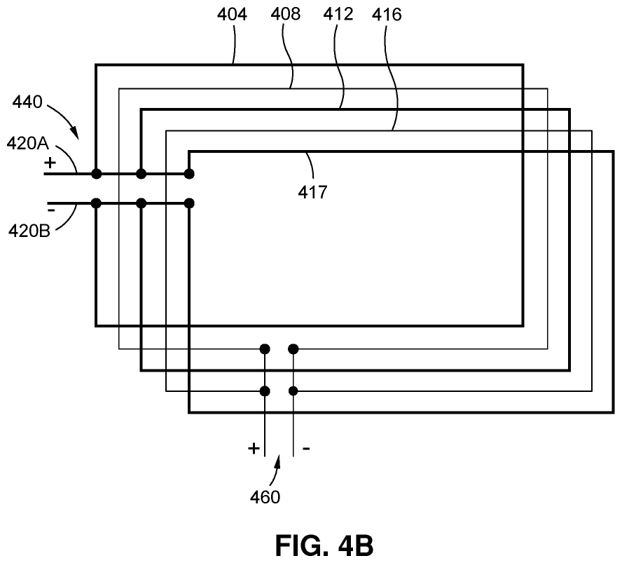

FIG. 4A illustrates an alternative winding structure with windings configured as diagonally offset triangle shapes. As with the other embodiments, any number of windings may be utilized, and each winding may have any number of turns and any number of taps or terminals. Similarly, this configuration may be implemented with the waterfall structure and/or fractional turns. In this embodiment, there are three triangularly shaped windings which are diagonally offset as shown. The windings include a first winding 404, a second winding 408, and a third winding 412. The first winding has a first winding terminal 420, while the third winding has a third winding terminal 424. These terminals connect as shown to form terminal 428. The secondary side winding 404 is interleaved between the two primary side windings 404, 412 to optimize energy transfer. The first winding 404 and the third winding 412 may be considered the primary side windings, while the second winding 408 may be considered the secondary side winding. The second winding 404 has a terminal 440. This embodiment has an even to odd structure such that there are two windings connected to the first terminal 428 and one winding connected to the second terminal 440.

At crossover areas 430A, 430B the windings cross and will be routed using vias to a lower or an upper layer as discussed in FIG. 2B. One challenge that must be overcome with the triangle configuration is the acute angle at which windings overlap and transition to a different direction, which can violate certain design rules and require more area to build for a given inductance, as compared to the square configuration. The windings in the triangle embodiment, as with the square embodiment, are generally parallel and thus maximize inductive transfer between windings. Other shapes in addition to a square shape and triangular shape are disclosed herein. However, as the shapes become circular, such as an octagon shape, processing as integrated circuits or layers becomes difficult or impossible. Other shapes include rectangles, pentagons, or variations of any shape disclosed herein which are offset as disclosed herein.

It is also contemplated that the shape may be a rectangle shape instead of a squ are as shown in FIG. 4B. In one embodiment there may be three primary side windings such that the secondary winding is sandwiched or interleaved between the three primary side windings to maximize coupling from the primary side windings to the secondary side winding. This is similar to the structure of FIG. 2C, but in a rectangular shape. Similarly, the structure could be a two to three winding structure or a three to two winding structure. Thus, there can be an even and odd number of windings in either the primary or secondary windings, or the same number of windings. Often, although not required, the primary side will have an even number of windings, while the secondary side will have an odd number of windings. FIG. 4B illustrates an example embodiment of a transformer winding arrangement with rectangular shaping windings. There are three primary side windings 404, 412, 417 which sandwich the secondary side windings 408, 416 to optimize coupling. The primary side as an input terminal 440 that includes inputs 420A, 420B while the secondary side has output terminal 460. The distance between windings may vary as may the thickness of each winding wire or trace. These windings may be connected in parallel because each winding will generally have the same inductance. When placed in parallel, if the inductance is not the same, the transformer operation will be disrupted. As shown in FIG. 17B, each winding has generally the same length and thus the same impedance. Offsetting each winding does not change the distance of each winding.

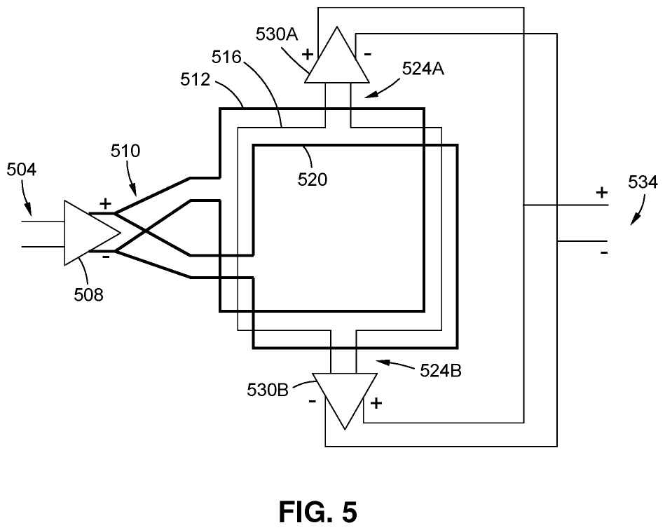

FIG. 5 illustrates an example embodiment of a transformer with coupled windings and the coupled windings connect to amplifiers as shown. This creates a 1:½ winding ratio with output amplifiers. This steps down the signal and then amplifies the signal. As shown an input terminal 504 connects to an input of an amplifier 508. The amplifier output 510 connects to the inputs of a first winding 512 and a third winding 520 to form the primary side windings. Interleaved or sandwiched between the two windings 512, 520 of the primary side, is a secondary side winding 516 that is the secondary side winding. The secondary side winding 516 has two output terminals 524A, 524B which connect to output amplifiers 530A, 530B respectively. The output of the output amplifiers 530A, 530B are tied together at an output 534.

Although shown as a voltage step down transformer, other embodiments are contemplated. For example, there may be a greater or fewer number of windings on the primary side and/or the secondary side. In addition, fractional turns may be provided on the primary side, the secondary side, or both. Likewise, any fractional winding values may be on the primary side and/or the secondary side. Devices in addition to or different than, the amplifiers, may or not be connected to the input and/or output of the windings.

FIG. 6A illustrates an alternative winding structure with a central twist forming two or more square or rectangular shapes. This structure includes a twist also referred to as a pretzel transformer structure such that the winding shape disclosed in FIG. 1 is rotated about its midpoint or other location. This forms two smaller squares (or rectangles) with one or more intersection or cross-over locations. As shown in FIG. 6A, a square shaped winding 608 is shown in dashed line. This shape is shown and described above. Although shown as a square, any shape shown or described above is contemplated for the disclosed modification. The generally square structure 608 is modified by twisting it about its midpoint (or other location between two corners), to form two smaller squares 612A, 612B. This forms a continuous path from the positive and negative terminals 616 of the winding. At the crossover point 620 of the winding is a jumper 624 which jumps one winding path over the other winding path. Two vias 630 extend from the jumper 624 to the winding path.

As can be observed in FIG. 6A, the length of the twisted winding 612A, 612B is the same as the example square winding shape 608. For example, the length A1 plus length A2 is the same as length A3. This same property is true for each of the sides of the windings. In addition, the shape of the twisted windings 612A, 612B meets the fabrication process rules by having only right angles between connecting lines.

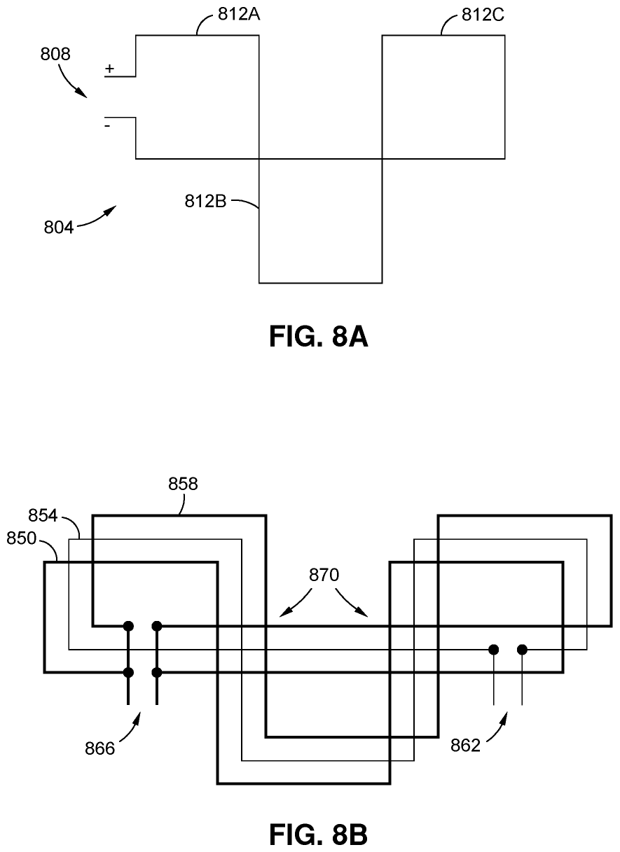

Although described above as a larger square or rectangle shape that is twist about a center point, this configuration may also be described in terms of the shape of the transformer. As such, the winding (conductive path) may appear as two or more squares or rectangles that are arranged corner to corner. At the corners, as the conductive trace transitions from one of the shapes (square or rectantangle) to the next shape, a jumper may be used to route one of the conductor to a different layer (using vias) to avoid shorting contact in the winding. FIG. 6A is an example of a transformer winding being in the shape of two squares. FIG. 7 is an example for the transform winding being in the shape of three squares. FIG. 8B is an example for the transform winding being in the shape of three rectangles. Various other shapes and combination are contemplated, such as a combination of square and rectangular shapes, which may be diagonally offset as described herein.

FIG. 6B illustrates a perspective view of a jumper and via configuration which prevents intersecting windings from touching. This is described in FIGS. 2B and 6A. As shown, the path of a first winding conductive path 650A, 650B would intersect a second winding conductive path 662 as these two winding conductive paths are in the same plane or layer. To prevent this intersection, which would short the two windings, conductive vias 654A, 654B are provided which extend to a different layer or plane. At the different layer or plane, a conductive jumper 658 extends between and electrically connects the two vias 654A, 654B. This prevents electrical contact between the winding 650A, 650B and winding 662. Although shown with the via extending downward to a lower layer, it is contemplated that the vias could instead extend upward to an upper layer. The structure may be configured such that the jumper 658 bypasses several windings, such as additional windings besides winding 662. For example, in FIG. 2B, the jumper between vias 280A, 280B extends under (or over) three windings. In FIG. 7, vias and jumpers would be used to not only prevent contact between other windings, but also at twist points in windings, such as at 730A, 730B. Between the layer on which the majority of the windings are located and the jumper layer is an insulating layer or insulating material 690 as is typical between layers or conductors of a semiconductor or printed circuit board. The via would extend through the insulating layer. The insulating prevents the conductive traces in a layer from shorting or contacting a conductive trace in a different layer (such as an upper or lower layer).

Turning now to FIG. 7, a twisted transformer structure is disclosed using two or more of the twisted windings which are diagonally offset as disclosed herein. FIG. 7 illustrates a primary side terminal 720 formed from a first winding 708 and a third winding 716 which are connected in parallel as shown. Interleaved between the first winding 708 and a third winding 716 is a second winding 712 that forms the second side of the transformer. The secondary side has a secondary side transformer 724. Each of the primary side windings and secondary side windings include two twists or pretzel rotations 730A, 730B.

As discussed above, at each intersection of winding conductors, a via to an upper or lower layer, connects to jumper that extends in the upper or lower layer, to another via that returns the conductive path to the main layer in which the transformer is formed. For example, at the first twist 730A, there will be three jumpers, one for each conductive path. For example, the winding 716 on the main layer that extends in a horizontal direction at the first twist 730A, will extend upward or downward through a via to a different layer, cross over the three other intersecting windings that remain on the main layer, and then through a via back to the main layer.

Although shown with a square shape and two twists, it is contemplated that the windings, before or after the twist process, may assume different shapes. For example, and not limited to, the original shape may be a rectangle, which is then twisted or pretzeled into two or more small pretzels. In addition, any number of twists may be established, however, two to four twists or overlaps are typically the most efficient. This results in two to four square or rectangular shapes per winding. In addition, although the twist or pretzel shape reduces the interior area of the windings of the transformer, the high K (coupling) coefficient overcomes the small reduction in K factor due to the reduced interior area. In prior art designs, a reduction in interior area will lower the K value in a prior art design that already.

It is also contemplated that the smaller winding shapes may be arranged in different configuration. FIG. 8A illustrates an alternative winding configuration 804 with an input terminal 808 that connects to one winding that which is twisted into three smaller square windings 812A, 812B, 812C. Jumpers are provided at each overlap. To create a transformer, two or more of these windings would be offset and interleave to create primary side windings and secondary side windings of the transformer. Other configurations are contemplated than that shown in FIG. 8A.

FIG. 8B illustrates an alternative winding configuration with rectangular windings. This embodiment is generally similar to the configuration of FIG. 7, however the first winding 850, second winding 854, and third winding 858 are formed into three rectangular shapes. The second winding is shown in dashed lines to more clearly identify the second winding. As discussed herein, the primary and secondary windings may be reversed or swapped. In this embodiment, a primary side winding terminal 862 connects to the second winding 854. The second winding 854 is located between the first winding 850 and the second winding, which form the secondary side windings. A secondary side terminal 866 connects to the first and second windings 850, 858 as shown. Each of the windings is offset and shifted. Two twist locations 870 are shown and jumpers (not shown) are located at these twists locations 870 to prevent windings from touching. The size and shape of the windings, and the distance between windings, may be adjusted to flexibly accommodate IC or circuit board space limitations.

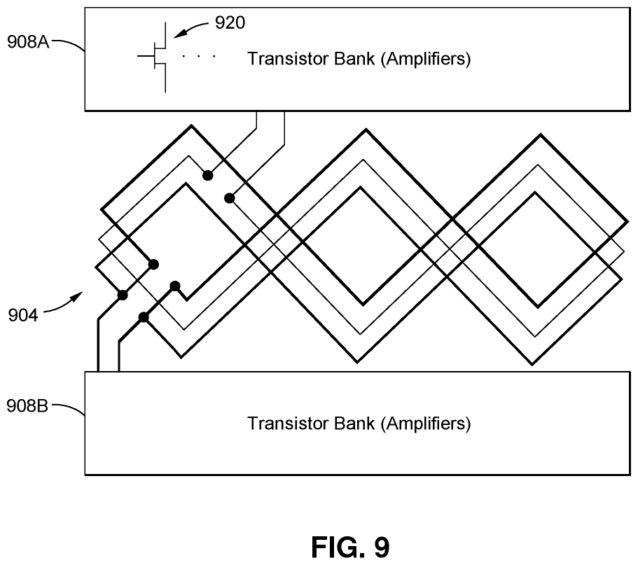

FIG. 9 illustrates an exemplary twisted transformer structure and associated transistor banks. As shown, the transformer 904 is rotated 90 degrees as compared to the twisted transformer structure shown in FIG. 7. Rotating the twisted transformer structure 904 does not change the electrical properties of the transformer and still meets all the fabrication/manufacturing rules. In particular, process rules allow for diagonal lines such as shown which form the primary side and secondary side windings, which after being rotated appear as diamond shapes. Rotating the transformer does however provide the benefit of establishing ideal alignment, with or for, one or more transistor based structures 908A, 908B, such as but not limited to amplifier(s). Manufacturing processing (fabrication) alignment preferences and/or requirements when fabricating integrated circuit discourages or won't allow for transistors fabricated on a diagonal. By twisting and rotating the transformer 904, the transistors 920 in the transistor banks may be fabricated in an allowed alignment and not on the diagonal. Fabrication process allows for the conductive paths of the windings to be arranged in a diagonal direction. This arrangement also provides the benefit of improve space utilization be reducing the area on the interior of the windings to thereby fit the transistor based structures 908A, 908B and the transformer in a space that is no larger than the transformer structure in a non-twisted configuration.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A transformer comprising:
a first signal path in a first plane;
a second signal path, in the first plane, that is offset in a diagonally direction in relation to the first signal path, wherein the first signal path and the second signal path are in proximity to establish electric-field coupling between the first signal path and the second signal path.
a jumper, located in a second plane, connected to either the first signal path or the second signal path to prevent electrical contact between the first signal path and the second signal path.

2. The transformer of claim 1 wherein the first signal path comprises one or more windings and the second signal path comprise one or more windings, and the transformer is formed in an integrated circuit or a printed circuit board.

3. The transformer of claim 1 wherein the jumper is connected to the first signal path or the second signal path with vias that extend from the second plane to the first plane.

4. The transformer of claim 1 wherein the first signal path comprises one or more windings connected in parallel and the second signal path comprises one or more windings connected in parallel, and the first signal path and second signal paths are in the shapes of squares or rectangles.

5. The transformer of claim 1 wherein the first signal path includes one or more input terminals, and the second signal path includes one or more output terminals.

6. The transformer of claim 1 where the primary side and the secondary side are a twisted structure which forms a twisted transformer configuration.

7. The transformer of claim 1 wherein the first signal path, the second signal path, or both comprise fractional turn windings.

8. The transformer of claim 1 wherein the first signal path forms two or more square or rectangular shapes and the second signal path is of the same general shape as the first signal path.

9. A transformer comprising:
a first primary side winding, electrically connected a primary side terminal, located in a first layer of a semiconductor device or printed circuit board;
a second primary side winding, electrically connected to the primary side terminal, located in the first layer
a secondary side winding, electrically connected to a secondary side terminal, located in the first layer, wherein the secondary side winding is located between the first primary side winding and the second primary side winding such that the first primary side winding, second primary side winding, and the secondary side winding are diagonally offset from one another and in proximity to establish for electric field coupling.

10. The transformer of claim 9 further comprising:
two or more vias that connect to at least one of the windings and extend to a layer different then the first layer, and
one or more jumpers that connect to at least two of the two or more vias to route two or more windings to a different layer to prevent electrical connection between the windings which are in the first layer.

11. The transformer of claim 9 further comprising insulating material on the first layer between the first primary side winding and the secondary side winding and between the secondary side winding and the second primary side winding to prevent electrical connection between the windings.

12. The transformer of claim 9 wherein the transformer is configured as a step-up transformer or a step-down transformer.

13. The transformer of claim 9 further comprising one or more amplifiers connected to the primary side terminal, the secondary side terminal, or both.

14. The transformer of claim 9 wherein the primary side winding, the secondary side winding, or both are fractional turn windings.

15. A transformer structure comprising:
one or more primary side windings forming a conductive path between two terminals, the primary side windings in the shape of two or more squares, rectangles or combination of both;
one or more secondary side windings having the same shape as the one or more primary side windings, but which are diagonally offset from the one or more primary side winding and adjacent at least one of the one or more primary side windings to experience electric field coupling from the at least one of the one or more primary side windings.

16. The transformer structure of claim 15 further comprising jumpers on a different layer to prevent electrical contact between the primary side windings and the secondary side windings, and wherein the one or more primary side windings and the one or more secondary side windings are on a same layer, except for the jumpers which are on the different layer.

17. The transformer structure of claim 16 further comprising, at overlap points between the one or more primary side windings and/or the one or more secondary side windings, vias that extend to a jumper that is a different layer to prevent the conductive paths from touching at overlap points.

18. The transformer structure of claim 15 wherein the one or more primary side winding has one or more input terminals, and the secondary side winding has one or more output terminals.

19. The transformer structure of claim 15 wherein the one or more secondary side windings are interleaved with the between or more primary side windings.

20. The transformer structure of claim 15 wherein the one or more primary side windings and the one or more secondary side windings are in the shape of two or more diamonds which are adjacent transistors.
